(19) United States
(12) Patent Application Publication
(10) Pub. No.: US 2015/0046957 A1
(43) Pub. Date: Feb. 12, 2015

(54) TVOD SONG PLAYING METHOD AND PLAYER THEREFOR

(71) Applicants: Peking University Founder Group Co., Ltd., Beijing (CN); Beijing Founder Electronics Co., Ltd., Beijing (CN); Founder Information Industry Group, Beijing (CN)

(72) Inventors: Leichuan LI, Beijing (CN); Xuejun CAO, Beijing (CN); Peng LIANG, Beijing (CN)

(73) Assignees: Peking University Founder Group Co., Ltd., Beijing (CN); Beijing Founder Electronics Co., Ltd., Beijing (CN); Founder Information Industry Group, Beijing (CN)

(21) Appl. No.: 14/093,791

(22) Filed: Dec. 2, 2013

(30) Foreign Application Priority Data
Aug. 6, 2013 (CN) 201310339774.2

(51) Int. Cl. H04N 21/472; H04N 21/439

(52) U.S. Cl. CPC H04N 21/47217; H04N 21/439
USPC 725/88

(57) ABSTRACT

An embodiment of the present invention provides a TVOD song playing method, comprising: assigning coordinates of a starting point and an end point to each sentence of lyrics; determining a coordinate of a click position; determining, according to the coordinate of the click position, coordinates of the starting point and the end point of lyrics to be played; and playing the lyrics corresponding to the coordinates of the starting point and the end point. Another embodiment of the present invention further provides a TVOD song player, comprising: a lyrics editing module, a coordinate determining module, and a playing module.

### BACKGROUND OF THE INVENTION

1. Field of the Invention

The embodiments of the present invention relates to a True Video On Demand (TVOD) song playing method and a player therefor.

2. Description of the Prior Art

With tremendous development of electronics technologies, more and more electronic teaching materials prevail in the market. Especially in the field of music education, electronic teaching materials are gradually replacing traditional paper-made teaching materials for such features as timeliness, shareability, dynamic, repeatability, and interactiveness. In the current electronic teaching materials on music, play progress of a song may be changed only by dragging a progress bar. When a user desires to replay a sentence of lyrics of a song, the progress bar needs to be repeatedly dragged forward or backward. In such cases, the user failed to accurately find the lyrics to be played, and meanwhile a large amount of time was wasted.

### SUMMARY OF THE INVENTION

To partially at least overcome the defects in the prior art, an embodiment of the present invention provides a TVOD (i.e., point-to-play) song playing method and a player therefor.

According to one aspect of the present disclosure, there is provided a TVOD song playing method, comprising: determining a coordinate of a click position; determining, according to the coordinate of the click position, coordinates of a starting point and an end point of lyrics to be played; and playing the lyrics corresponding to the coordinates of the starting point and the end point.

According to another aspect of the present disclosure, there is provided a TVOD song player, comprising: a lyrics editing module, a coordinate determining module, and a playing module. The lyrics editing module is configured to assign coordinates of a starting point and an end point to each sentence of lyrics; the coordinate determining module is configured to determine a coordinate of a click position, and determine, according to the coordinate of the click position, coordinates of the starting point and the end point of lyrics to be played; and the playing module is configured to play the lyrics corresponding to the coordinates of the starting point and the end point.

As described above, by using the TVOD song playing method and the player therefor according to the present disclosure, the playing process of a song is more visualized such that a user is capable of quickly and accurately selecting lyrics to be played, which brings great convenience to the user as a result.

### BRIEF DESCRIPTION OF THE DRAWINGS

FIG. 1 is a schematic diagram illustrating a TVOD song player according to an exemplary embodiment of the present invention;

FIG. 2 is a schematic diagram illustrating a lyrics editing module according to an exemplary embodiment of the present invention; and

FIG. 3 is a flowchart illustrating a TVOD song playing method according to an exemplary embodiment of the present invention.

### DETAILED DESCRIPTION OF THE PREFERRED EMBODIMENTS

For a better understanding of the present invention, the present invention is described in detail with reference to the accompanying drawings. It should be understood that the drawings and detailed description serve to illustrate the exemplary embodiments of the present invention, but are not intended to limit the scope of the present invention.

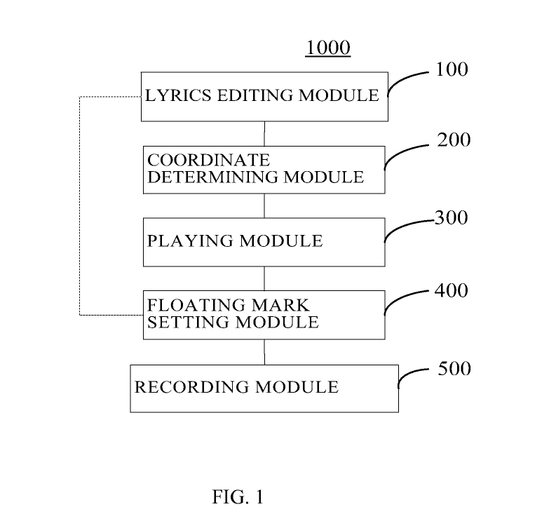

FIG. 1 exemplarily illustrates a TVOD song player 1000 according to an embodiment of the present invention. The player 1000 may, for example, run on such electronic devices as computers, smart phones, and tablet computers, and may support a plurality of music formats, for example, MP3, WMA, WAV, MOD, RA, CD, and MD. As illustrated in FIG. 1, the player 1000 may include a lyrics editing module 100, a coordinates determining module 200, and a playing module 300.

The lyrics editing module 100 may be configured to assign coordinates of a starting point and an end point to each sentence of lyrics. In an embodiment of the present invention, the lyrics editing module 100 may identify multiple languages, comprising: Chinese, English, Japanese, Korean and so on, and may also divide the lyrics into sentences according to settings made by a user when inputting the lyrics.

The coordinate determining module 200 may be configured to determine a coordinate of a click position, and determine, according to the coordinate of the click position, the coordinates of the starting point and the end point of lyrics to be played. In an embodiment of the present invention, the click position may be any play position on a playing page. After a user clicks on a playing page, the coordinates determining module 200 may firstly determine the coordinate of the click position, and then determine, according to the coordinate of the click position, the coordinates of the starting point and the end point of the lyrics to be played. For example, according to an embodiment of the present invention, the lyrics editing module 100 may assign a starting coordinate 1 and an end coordinate 10 to the first sentence of lyrics; and if the coordinates determining module 200 determines that the coordinate of the click position is 8, it may be determined that the click position is located in the first sentence of lyrics, and the coordinates of the starting point and the end point of the sentence of lyrics are respectively 1 and 10, and so on.

The playing module 300 may be configured to play the lyrics corresponding to the coordinates of the starting point and the end point. In an embodiment of the present invention, the play mode may be Once, Loop, and the like.

In addition, as illustrated in FIG. 1, the player 1000 may further include a floating mark setting module 400 and a recording module 500. The floating mark setting module 400 may be configured to set a floating mark capable of following a movement of the text of the lyrics according to the assigned coordinates during song playing, and thereby indicate playing progress. In an embodiment of the present invention, when the player starts playing a song, if the user randomly clicks a play position on the play page, the floating mark will quickly skipped to the click position. In this case, the song playing continues and the floating mark continues following along the text.

The recording module 500 may be configured to record ambient sounds to compare the same with a song being played. In an embodiment of the present invention, during song playing, the song playing may be paused, and the recording module 500 is used for recording sounds. After the recording, the recorded sounds may be played for comparison with the song playing.

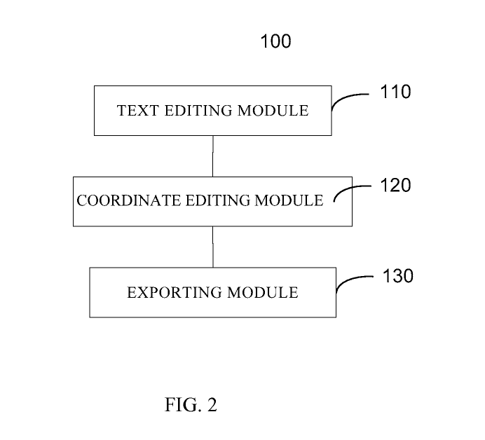

FIG. 2 exemplarily illustrates a lyrics editing module 100 according to an embodiment of the present invention. As illustrated in FIG. 2, the lyrics editing module 100 may include a text editing module 110, a coordinate editing module 120, and an exporting module 130.

The text editing module 110 may be configured to display text of each sentence of lyrics in the form of a list. The coordinate editing module 120 may be configured to assign corresponding coordinates of the starting point and the end point to the text of each sentence of lyrics. The exporting module 130 may be configured to export the lyrics that are assigned the coordinates of the starting point and the end point.

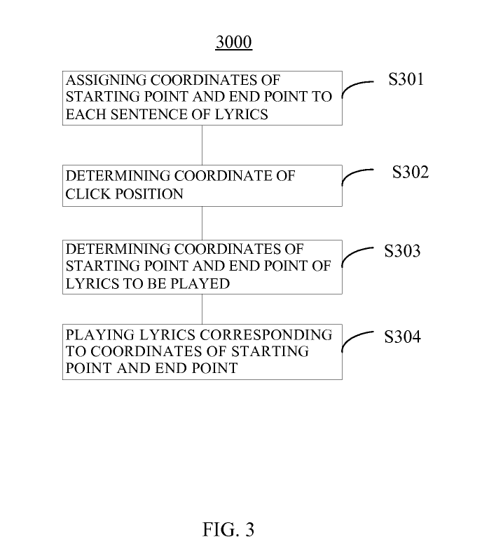

Referring to FIG. 3, detailed description is given on the process of implementing a TVOD song playing method 3000 by the TVOD song player 1000.

In step S301, the lyrics editing module 100 assigns coordinates of a starting point and an end point to each sentence of lyrics. In an embodiment of the present invention, the lyrics editing module 100 may, for example, divide the lyrics into sentences according to settings made by a user when inputting the lyrics, and then assign the coordinates of the starting point and the end point to each sentence of the lyrics. Specifically, the lyrics editing module 100 firstly display each sentence of the lyrics in the form of a list. Subsequently, the lyrics editing module 100 assigns corresponding coordinates of the starting point and the end point to the text of each sentence of lyrics. Afterwards, the lyrics editing module 100 exports the lyrics that are assigned the coordinates of the starting point and the end point.

In step S302, the coordinate determining module 200 determines a coordinate of a click position.

Subsequently, in step S303, the coordinate determining module 200 determines, according to the coordinate of the click position, the coordinates of the starting point and the end point of lyrics to be played. In an embodiment of the present invention, the click position may be any play position on a play page. After a user clicks on the play page, the coordinate determining module 200 may firstly determine the coordinate of the click position, and then determine, according to the coordinate of the click position, the coordinates of the starting point and the end point of the lyrics to be played.

In step S304, the playing module 300 plays the lyrics corresponding to the coordinates of the starting point and the end point. According to an embodiment of the present invention, the play mode may be Once, Loop, and the like.

Detailed above are exemplary embodiments for illustrating the present invention. It should be noted that these exemplary embodiments are not intended to limit the present invention. A person skilled in the art may derive various modifications and variations to the embodiments without departing from the spirit and scope of the present invention. The protection scope of the present invention is subject to the claims.

What is claimed is:

1. A True Video On Demand (TVOD) song playing method, comprising:
assigning coordinates of a starting point and an end point of each sentence of lyrics;
determining a coordinate of a click position;
determining the coordinates of the starting point and the end point of lyrics to be played, according to the coordinate of the click position; and
playing the lyrics corresponding to the determined coordinates of the starting point and the end point.

2. The method according to claim 1, wherein the assigning coordinates of a starting point and an end point of each sentence of lyrics comprises:
displaying text of each sentence of lyrics in form of a list; and
assigning corresponding coordinates of the starting point and the end point to the displayed text of each sentence of lyrics.

3. The method according to claim 1, further comprising:
setting a floating mark capable of following a movement of the text of the lyrics according to the assigned coordinates during song playing, and thereby indicating a playing progress.

4. A TVOD song player, comprising:
a lyrics editing module, configured to assign coordinates of a starting point and an end point of each sentence of lyrics;
a coordinates determining module, configured to determine a coordinate of a click position, and determine, according to the coordinate of the click position, the coordinates of the starting point and the end point of lyrics to be played; and
a playing module, configured to play the lyrics corresponding to the determined coordinates of the starting point and the end point.

5. The player according to claim 4, wherein the lyrics editing module comprises:
a text editing module, configured to display text of each sentence of lyrics in form of a list; and
a coordinate editing module, configured to assign corresponding coordinates of the starting point and the end point to the displayed text of each sentence of lyrics; and
an exporting module, configured to export the lyrics that have been assigned the coordinates of the starting point and the end point.

6. The player according to claim 4, further comprising:
a floating mark setting module, configured to set a floating mark capable of following a movement of the text of the lyrics according to the assigned coordinates during song playing, and thereby indicate a playing progress.

7. The player according to claim 4, further comprising:
a recording module, configured to record ambient sounds to compare the same with the song being played.
